(19) United States
(12) Patent Application Publication
(10) Pub. No.: US 2015/0086862 A1
(43) Pub. Date: Mar. 26, 2015

(54) NONAQUEOUS ELECTROLYTE SECONDARY BATTERY AND BATTERY PACK

(71) Applicant: KABUSHIKI KAISHA TOSHIBA, Tokyo (JP)

(72) Inventors: Norikazu OSADA, Tokyo (JP); Shinsuke MATSUNO, Tokyo (JP); Keiko OKAMOTO, Kawasaki (JP); Takayuki FUKASAWA, Yokohama (JP); Takashi KUBOKI, Tokyo (JP)

(21) Appl. No.: 14/478,128

(22) Filed: Sep. 5, 2014

(30) Foreign Application Priority Data
Sep. 24, 2013 (JP) 2013-197503

(51) Int. Cl. H01M 10/0567; H01M 10/05; H01M 4/36

(52) U.S. Cl. CPC H01M 10/0567; H01M 4/364; H01M 10/05; H01M 2220/30; H01M 2300/0025
USPC 429/200; 429/199

(57) ABSTRACT

A nonaqueous electrolyte secondary battery of an embodiment includes a positive electrode, a negative electrode, and a nonaqueous electrolyte. The electrolyte contains an organic solvent with a lithium salt dissolved therein and an additive. An active material of the negative electrode contains at least one metal selected from Si and Sn, at least one or more selected from an oxide of the metal and an alloy containing the metal, and a carbonaceous matter. A fluorine concentration of a film A formed on the metal, the oxide of the metal, or the alloy containing the metal in the negative electrode active material is higher than a fluorine concentration of a film B formed on the carbonaceous matter, the additive includes at least one compound containing fluorine and at least one compound containing no fluorine, or an electrolyte after initial charge contains at least one fluorine-containing additive.

### CROSS-REFERENCE TO RELATED APPLICATION

This application is based upon and claims the benefit of priority from Japanese Patent Application No. 2013-197503, filed on Sep. 24, 2013; the entire contents of which are incorporated herein by reference.

### FIELD

Embodiments described herein relate to a nonaqueous electrolyte secondary battery and a battery pack.

### BACKGROUND

In recent years, various portable electronic devices are becoming popular, with the rapid advancement of miniaturization technology for electronics. Further, batteries as power sources for the portable electronic devices are also required to be reduced in size, and nonaqueous electrolyte secondary batteries with a high energy density have been attracting attention.

Nonaqueous electrolyte secondary batteries which use metal lithium as a negative electrode active material have an extremely high energy density, but have a short battery life because dendritic crystals referred to as dendrite are deposited on negative electrodes during charge, and also have problems with safety, such as internal short circuit caused by the dendrite grown to reach positive electrodes. Therefore, carbon materials, in particular, graphitizable carbon (graphite) for storing and desorbing lithium have come to be used as a negative electrode active material in place of the lithium metal.

Furthermore, attempts have been made to use, as negative electrode active materials for further pursuing a higher energy density, high-density substances which are high in lithium storage capacity, such as, in particular, elements such as silicon and tin, which are alloyed with lithium, and amorphous chalcogen compounds. Above all, silicon is able to store lithium up to a ratio of 4.4 lithium atoms to a silicon atom, and the capacity of the negative electrode per mass is approximately 10 times as high as that of graphitizable carbon. However, silicon undergoes a substantial change in volume with insertion/desorption of lithium in charge-discharge cycles, and has problems with the cycle life, such as reductions in active material particle size.

### BRIEF DESCRIPTION OF THE DRAWINGS

FIG. 1 is a conceptual diagram of a flat nonaqueous electrolyte battery according to an embodiment;

FIG. 2 is an enlarged schematic diagram of a section A in FIG. 1;

FIG. 3 is a conceptual diagram of a battery pack according to an embodiment;

FIG. 4 is a block diagram illustrating an electric circuit of a battery pack according to an embodiment;

FIG. 5 is a TEM cross-sectional image in an example; and

FIG. 6 is a TEM cross-sectional image in an example.

### DETAILED DESCRIPTION

A nonaqueous electrolyte secondary battery of an embodiment includes a positive electrode containing at least a positive electrode active material, a negative electrode containing at least a negative electrode active material, and a nonaqueous electrolyte. The nonaqueous electrolyte contains an organic solvent with a lithium salt dissolved therein and an additive. The negative electrode active material contains at least one metal selected from Si and Sn, at least one or more selected from an oxide of the metal and an alloy containing the metal, and a carbonaceous matter. A fluorine concentration of a film A formed on the metal, the oxide of the metal, or the alloy containing the metal in the negative electrode active material may be higher than a fluorine concentration of a film B formed on the carbonaceous matter. The additive may include at least one compound containing fluorine and at least one compound containing no fluorine. An electrolyte after initial charge may contain at least one fluorine-containing additive.

A battery pack of an embodiment includes a nonaqueous electrolyte secondary battery of an embodiment. The nonaqueous electrolyte secondary battery includes a positive electrode containing at least a positive electrode active material, a negative electrode containing at least a negative electrode active material, and a nonaqueous electrolyte. The nonaqueous electrolyte contains an organic solvent with a lithium salt dissolved therein and an additive. The negative electrode active material contains at least one metal selected from Si and Sn, at least one or more selected from an oxide of the metal and an alloy containing the metal, and a carbonaceous matter. A fluorine concentration of a film A formed on the metal, the oxide of the metal, or the alloy containing the metal in the negative electrode active material may be higher than a fluorine concentration of a film B formed on the carbonaceous matter. The additive may include at least one compound containing fluorine and at least one compound containing no fluorine. An electrolyte after initial charge may contain at least one fluorine-containing additive.

The inventors have found, as a result of earnestly making experiments, that in the case of a negative electrode active material obtained by compounding and firing finely-divided silicon monoxide and a carbonaceous matter, the active material is obtained in which microcrystalline Si encapsulated or retained by SiOₓ (1<x≦2) binding to the Si tightly can be dispersed in the carbonaceous matter to achieve the increased capacity and improved cycle characteristics. However, in the case of a nonaqueous secondary battery which uses, for a negative electrode active material, a Si—SiOₓ—C composite obtained by compounding finely-divided silicon monoxide and a carbonaceous matter, the charge/discharge efficiency during charge/discharge is low, and thus the charge/discharge efficiency is required to be improved.

In the case of a negative electrode which uses graphite as a common negative electrode active material, an electrolytic solution is reductively decomposed on the surface of the negative electrode to decrease the charge/discharge efficiency during the initial stage of charge/discharge, while the formation of a solid electrolyte interface film (SEI (Solid Electrolyte Interface) film) on the surface of the negative electrode active material keeps the subsequent charge/discharge efficiency at a high level, and also improves the cycle life. However, in the case of using, for a negative electrode active material, a Si—SiOₓ—C composite obtained by compounding and firing finely-divided silicon monoxide and a carbonaceous matter, it has been found that the decrease in charge/discharge efficiency during the first charge/discharge is caused mainly by the reductive decomposition of the electrolytic solution on the surface of the negative electrode, and in addition, by irreversible reaction of SiOₓ contained in the active material with lithium.

Moreover, this negative electrode active material undergoes a substantial expansion/contraction in volume with charge/discharge, and thus has the problem of, due to repeated charge/discharge, cracking the active material, collapsing the film initially formed on the surface of the negative electrode active material, and progressing the decomposition of the electrolytic solution to decrease the charge/discharge efficiency during the charge-discharge cycle.

A nonaqueous electrolyte secondary battery according to an embodiment will be described. The nonaqueous electrolyte secondary battery according to an embodiment includes a nonaqueous electrolyte battery including: a positive electrode containing at least a positive electrode active material; a negative electrode containing at least a negative electrode active material; and a nonaqueous electrolyte, where the nonaqueous electrolyte contains therein an organic solvent with a lithium salt dissolved therein and an additive, and the negative electrode active material contains therein at least one metal selected from Si and Sn, at least one or more selected from an oxide of the metal and an alloy containing the metal, and a carbonaceous matter. More specifically, the nonaqueous electrolyte secondary battery includes: an exterior member; a positive electrode housed in the exterior member; a separator housed in the exterior member; the negative electrode housed in the exterior member so as to be spatially separated from the positive electrode via, for example, the separator; and a nonaqueous electrolyte filled in the exterior member.

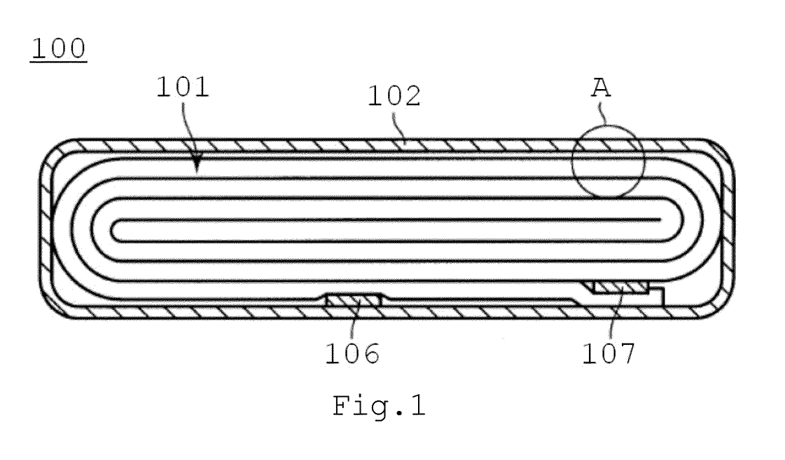

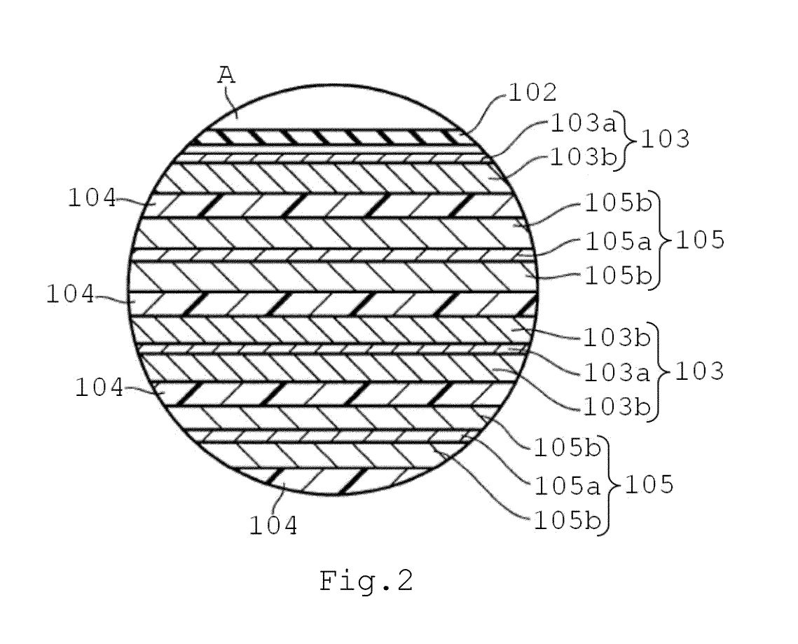

A more detailed explanation will be given with reference to the conceptual diagrams of FIGS. 1 and 2 illustrating an example of a nonaqueous electrolyte secondary battery according to an embodiment. FIG. 1 is a conceptual diagram of a cross section of a flat nonaqueous electrolyte secondary battery with an exterior member 102 of a laminated film, and FIG. 2 is an enlarged cross-sectional view of a section A in FIG. 1. It is to be noted that although the respective drawings are conceptual diagrams for convenience of description, where the shapes, sizes and ratios, etc. may be thus different from those of the actual battery, these designs can be changed as appropriate in consideration of the following descriptions and known techniques.

A flat rolled electrode group 101 is housed in the exterior member 102 of the laminated film with aluminum foil interposed between two resin layers. The flat rolled electrode group 101 is formed by rolling a stacked product of a negative electrode 103, a separator 104, a positive electrode 105, and a separator 104 stacked in this order from the outer side into a spiral form, and pressing the rolled product. The outermost negative electrode 103 is configured to have, as shown in FIG. 2, a negative electrode mixture 103b formed on one surface of the inner surface of a negative electrode current collector 103a. The other negative electrode 103 is configured to have negative electrode mixtures 103b formed on both surfaces of the negative electrode current collector 103a. The active material in the negative electrode mixtures 103b contains a battery active material 100 according to a second embodiment. The positive electrode 105 is configured to have positive electrode mixtures 105b formed on both surfaces of a positive electrode current collector 105a.

In the vicinity of an outer circumferential end of the rolled electrode group 101, a negative terminal 106 is electrically connected to the negative electrode current collector 103a of the outermost negative electrode 103, and a positive terminal 107 is electrically connected to the positive electrode current collector 105a of the inner positive electrode 105. The negative terminal 106 and the positive terminal 107 are extended out through openings of the exterior member 102. For example, a nonaqueous electrolyte in the form of liquid is injected through the openings of the exterior member 102. The rolled electrode group 101 and the liquid nonaqueous electrolyte are hermetically enclosed perfectly by heat-sealing the openings of the pouched exterior member 102 with the negative terminal 106 and positive terminal 107 inserted in the openings.

Examples of the negative terminal 106 include, for example, aluminum, and aluminum alloys containing elements such as Mg, Ti, Zn, Mn, Fe, Cu and Si. The negative terminal 106 is preferably made from a material similar to that for the negative electrode current collector 103a, in order to reduce the contact resistance between the negative terminal 106 and the negative electrode current collector 103a.

For the positive terminal 107, a material can be used which are electrically stable and conductive, with the electric potential in the range of 3 V to 4.3 V with respect to lithium ion metal. Specific examples of the material include aluminum, and aluminum alloys containing elements such as Mg, Ti, Zn, Mn, Fe, Cu and Si. The positive terminal 107 is preferably made from a material similar to that for the positive electrode current collector 105a, in order to reduce the contact resistance between the positive terminal 107 and the positive electrode current collector 105a.

The pouched exterior member 102, positive electrode 105, negative electrode 103, electrolyte and the separators 104, which are the constituents of the nonaqueous electrolyte secondary battery, will be described below in detail.

1) Exterior Member 102

The exterior member 102 is formed from a laminated film of, for example, 0.5 mm or less in thickness. Alternatively, a metallic container of 1.0 mm or less in thickness is used for the exterior member. The metallic container is more preferably 0.5 mm or less in thickness.

The shape of the exterior member 102 can be selected from flat (thin), square, cylinder, coin, and button shapes. Examples of the exterior member include, for example, exterior members for small-size batteries for use in mobile electronic devices etc. and exterior members for large-size batteries for use in two- to four-wheeled vehicles etc., depending on the battery sizes.

For the laminated film, a multilayer film is used which has a metal layer interposed between the resin layers. The metal layer is preferably aluminum foil or aluminum alloy foil, for the reduction in weight. For the resin layers, polymer materials can be used, such as polypropylene (PP), polyethylene (PE), nylon, and polyethylene terephthalate (PET). The laminated film can be subjected to heat sealing, and formed into the shape of the exterior member.

The metallic container is made from aluminum or an aluminum alloy or the like. The aluminum alloy is preferably an alloy containing an element such as magnesium, zinc, silicon etc. In the case where the alloy contains a transition metal such as iron, copper, nickel, chromium or the like, the amount of the transition metal is preferably 100 ppm by mass or less.

2) Positive Electrode 105

The positive electrode 105 is structured such that the positive electrode mixture(s) 105b containing an active material is/are supported on one or both surfaces of the positive electrode current collector 105a.

In terms of maintaining the large-current discharge characteristics and cycle life of the battery, the positive electrode mixture 105b desirably falls within the range of 1.0 μm or more and 150 μm or less in thickness for each surface. Therefore, in the case where the positive electrode mixtures 105b is supported on both surfaces of the positive electrode current collector 105a, the total thickness of the positive electrode mixtures 105b desirably falls within the range of 20 μm or more and 200 μm or less. A more preferred range of the thickness for each surface is 20 μm or more and 120 μm or less. The thickness within this range improves the large-current discharge characteristics and cycle life.

The positive electrode mixture 105b may contain a conductive agent besides the positive electrode active material.

The positive electrode mixture 105b may contain a binding agent for binding the positive electrode materials to each other.

Preferred as the positive electrode active material are various oxides, for example, manganese dioxide, lithium-manganese composite oxides, lithium-containing cobalt oxides (e.g., LiCoO₂), lithium-containing nickel-cobalt oxides (e.g., LiNi_{0.8}Co_{0.2}O₂), lithium-manganese composite oxides (e.g., LiMn₂O₄, LiMnO₂), because the use of the oxides achieves high voltage. Furthermore, the mixture may contain an efficiency adjusting material for adjusting the charge/discharge efficiency of the positive electrode/negative electrode.

Examples of the conductive agent include acetylene black, carbon black, and graphite.

Specific examples of the binding agent include, for example, polytetrafluoroethylene (PTFE), polyvinylidene fluoride (PVdF), ethylene-propylene-diene copolymer (EPDM), and styrene-butadiene rubber (SBR).

Preferred compounding proportions of the active material, conductive agent, and binding agent in the positive electrode mixture 105b respectively fall within the range of 60 mass % or more and 95 mass % or less, within the range of 3 mass % or more and 18 mass % or less, and within the range of 2 mass % or more and 7 mass % or less. These ranges are preferred because of the achievement of favorable large-current characteristics and cycle life.

As the current collector 105a, a porous or non-porous conductive substrate can be used. The current collector 105a is desirably 5 μm or more and 20 μm or less in thickness. This is because the thickness within this range achieves a balance between electrode strength and reduction in weight.

The positive electrode 105 is prepared by, for example, suspending the active material, conductive agent, and a binding agent in a general-purpose solvent to prepare slurry, applying the slurry to the current collector 105a, drying the applied slurry, and thereafter pressing the dried slurry. Alternatively, the positive electrode 105 may be prepared by forming the active material, conductive agent, and a binding agent into a pellet to serve as a positive electrode mixture 105b, and placing this pellet on the current collector 105a.

3) Negative Electrode 103

The negative electrode 103 is structured such that the negative electrode mixture 103b containing a negative electrode active material and other negative electrode material is supported in the form of a layer on one or both surfaces of the negative electrode current collector 103a. The thickness of the mixture desirably falls within the range of 1.0 μm or more and 150 μm or less for each surface. Furthermore, the thickness is more preferably 30 μm or more and 100 μm or less, which substantially improves the large-current discharge characteristics and cycle life.

In addition, the negative electrode mixture 103b may contain, besides the negative electrode active material, a conductive agent and a binding agent for binding the negative electrode materials to each other. For example, polytetrafluoroethylene (PTFE), polyvinylidene fluoride (PVdF), ethylene-propylene-diene copolymers (EPDM), styrene-butadiene rubbers (SBR), imide materials, etc. can be used as the binding agent for binding the negative electrode materials to each other. Examples of the conductive agent contained in the negative electrode mixture 103b include acetylene black, carbon black, and graphite. As the current collector, a porous or non-porous conductive substrate can be used. These conductive substrates can be formed from, for example, copper, stainless steel, or nickel. The current collector is desirably 5 μm or more and 20 μm or less in thickness.

The compounding proportions of the active material, conductive agent, and binding agent in the negative electrode mixture 103b respectively fall within the range of 35 mass, or more and 85 mass % or less, within the range of 10 mass % or more and 40 mass % or less, and within the range of 5 mass % or more and 25 mass % or less. These ranges are preferred because of the achievement of favorable large-current characteristics and cycle life.

While an active material including a Si phase, a SiOₓ phase, and a carbonaceous matter will be described below as an example, an active material includes: at least one metal selected from Si and Sn; at least one or more selected from oxides of the metal and alloys containing the metal; and a carbonaceous matter can be used as the negative electrode active material according to an embodiment.

A desirable embodiment of the negative electrode active material includes three phases of Si, SiOₓ, and a carbonaceous matter, and is a fine composite of the phases, where x of SiOₓ meets 1<x≧2. In addition, the Si phase inserts and desorbs a large amount of lithium, and significantly increases the capacity of the negative electrode active material. The expansion or contraction due to the insertion or desorption of a large amount of lithium into and from the Si phase is reduced by dispersing the Si phase into the other two phases, thereby preventing active material particles from being finely divided, and the carbonaceous matter phase ensures important conductivity as a negative electrode active material, whereas the SiOₓ phase binds to Si tightly to hold the finely-divided Si, which has a significant effect in maintaining the particle structure.

The Si phase is preferably expanded or contracted substantially when lithium is stored or released, and finely divided and dispersed as much as possible in order to relax the stress. Specifically, the Si phase is preferably dispersed as several nm clusters, or in a size less than or comparable to 500 nm.

The SiOₓ phase can adopt an amorphous or crystalline structure, but is preferably dispersed homogeneously in the active material particles in a manner that binds to, and encompass or hold the Si phase.

The carbonaceous matter may be graphite, hard carbon, soft carbon, amorphous carbon, or acetylene black, including one or more thereof, and preferably a mixture of graphite and hard or soft carbon. Graphite is preferred in terms of increase in the conductivity of the active material, and hard carbon and soft carbon have a significant effect in covering the whole active material and relaxing the expansion or contraction. The carbonaceous matter preferably encompasses therein the Si phase and the SiOₓ phase, in such a manner that the Si phase and the SiOₓ phase are partially exposed from the carbonaceous matter.

The negative electrode active material according to an embodiment has a SEI film derived from a fluorine-containing compound included in the electrolyte, and a SEI film derived from a compound containing no fluorine. The negative electrode active material according to an embodiment has two or more types of SEI films. The SEI films are formed on the surface of the negative electrode active material mainly by initially charging the secondary battery. The SEI films have the effect of preventing excessive decomposition of the electrolytic solution. However, in the case of an electrode with Si or the like as an active material, with the insertion/desorption of lithium during charge/discharge, the active material undergoes an expansion/contraction in volume, the SEI films fail to withstand the change in volume, and the SEI films are broken to progress the decomposition of the electrolytic solution or additives. Moreover, in the case of a negative electrode including the Si phase, SiOx phase, and carbonaceous matter, the Si phase and the SiOₓ phase are associated with substantial changes in volume during charge/discharge, whereas the carbonaceous matter undergoes a small change in volume. Due to this difference in coefficient of volume expansion, the SEI films are likely to be broken. However, in an embodiment, the active material has a film A derived from a fluorine-containing compound for coating the Si phase and SiOₓ phase of the negative electrode active material and a film B derived from a compound containing no fluorine for coating the carbonaceous matter. More specifically, due to the selectivity of the films according to an embodiment, the fluorine concentration of the film formed on the Si phase/SiOₓ phase in the negative electrode active material is higher than the fluorine concentration of the film formed on the carbonaceous matter. The Si/SiOₓ phase and the carbonaceous matter which differ in coefficient in volume expansion each have a different type of film, and film cracking can be thus prevented by volume expansion during charge. The prevention of film cracking improves the charge-discharge efficiency and cycle characteristics of the nonaqueous secondary battery during the cycle, as compared with cases of using conventional negative electrode active materials. It is to be noted that the coating or film according to an embodiment only has to cover at least a portion of the exposed phase of the active material, but does not necessarily have to cover the entire surface of the exposed phase.

Next, a method for producing a negative electrode active material for a nonaqueous secondary battery according to an embodiment will be described.

It is preferable to use SiO_{y} (0.8≦y≦1.5) as the Si raw material. In particular, it is desirable to use SiO (y≈1) for adjusting the quantitative relationship between the Si phase and the SiO_{X} phase to a preferred ratio. The form of the material is preferably powder, and 1 μm or more and 50 μm or less in average particle size. The SiO_{y} is separated into finely-divided Si phase and SiOₓ phase in a firing step as will be described later, and in order to ensure conductivity to the Si phase finely divided and dispersed, the particle sizes are preferably as small as possible. This is because when the particle sizes are large, the SiO phase as an insulator will thickly cover the Si phase at particle centers to interfere with the insertion/desorption function of lithium as an active material. Accordingly, the SiO_{y} is preferably 50 μm or less in particle size. However, the surface of the SiO_{y}, which is exposed to the atmosphere, is oxidized to be SiOₓ, and thus, when the particle sizes are extremely reduced, the surface area is increased to provide the surface with SiOₓ, thereby making the composition unstable. Accordingly, the average particle size is preferably 1 μm or more.

As a raw material for the carbonaceous matter, carbonaceous matters obtained by heating pitch, resins, polymers, etc., in an inert atmosphere can be used besides already carbonized materials such as graphite, acetylene black, carbon black, and hard carbon. It is preferable to use, as the carbonaceous matter, a combination of a highly electroconductive material such as graphite and acetylene black with an uncarbonized material such as polymers and pitch. The materials such as pitch and polymers melted or polymerized along with SiO_{y} at a stage prior to firing are able to provide a form of the SiO_{y} encapsulated in the carbonaceous matter. The firing temperature for carbonization in the production method according to embodiments is a relatively low temperature of 800° C. or higher and 1400° C. or lower, the carbonized pitch or polymer is thus not highly graphitized, and graphite, acetylene black, or the like is required in order to increase the conductivity of the active material.

A precursor before carbonization is prepared by mixing the SiO_{y} and the carbonaceous matter, and in the case of using pitch as the carbonaceous matter, the SiO_{y} and graphite or the like are mixed into melted pitch, solidified by cooling, then subjected to grinding to oxidize the surface so as not to be melted, and then subjected to firing for carbonization. Alternatively, in the case of using a polymer, graphite or the like and the SiO_{y} dispersed in a monomer are subjected to polymerization and solidification, and the polymerized and solidified product is subjected to firing for carbonization.

The firing for carbonization is carried out in an inert atmosphere such as in Ar. In the firing for carbonization, the polymer or pitch is carbonized, and the SiO_{y} is separated by disproportionation reaction into two phases of Si and SiOₓ. The reaction is expressed by the following formula (1) in the case of x=2 and y=1

2SiO→Si+SiO₂ (1)

This disproportionation reaction proceeds at a temperature of 800° C. or higher for separation into finely divided Si phase and SiOₓ phase, while the temperature of the firing for carbonization is preferably 800° C. or higher and 1400° C. or lower, more preferably 900° C. or higher and 1100° C. or lower, because Si reacts with carbon to produce SiC at higher temperatures than 1400° C. In addition, the firing time is preferably between 1 hour and on the order of 12 hours.

The negative electrode active material according to embodiments is obtained by the synthesis method as described above, and provided as an active material by adjusting the particle size, specific surface area, etc. with the use of various types of mills, grinding equipment, or the like.

4) Electrolyte

The electrolyte used can be a nonaqueous electrolytic solution, a polymer electrolyte impregnated with an electrolyte, a polymer electrolyte or an inorganic solid electrolyte.

The nonaqueous electrolytic solution is a liquid electrolytic solution prepared by dissolving an electrolyte in a nonaqueous solvent, and is retained in the voids in the electrode group. The composition of the electrolyte can be subjected to qualitative analysis and quantitative analysis by chromatography.

It is preferable to use, as the nonaqueous solvent, a nonaqueous solvent mainly containing a mixed solvent of propylene carbonate (PC) or ethylene carbonate (EC) with a nonaqueous solvent (hereinafter referred to as a second solvent) that is less viscous than PC or EC.

The second solvent is preferably, for example, chain carbon, and particularly, preferred examples include, dimethyl carbonate (DMC), methyl ethyl carbonate (MEC), diethyl carbonate (DEC), ethyl propionate, methyl propionate, γ-butyrolactone (BL), acetonitrile (AN), ethyl acetate (EA), toluene, xylene, and methyl acetate (MA). These second solvents can be used individually, or in the form of a mixture of two or more thereof. In particular, the number of donors is more preferably 16.5 or less in the second solvent.

The viscosity of the second solvent is preferably 2.8 cmp or less at 25° C. The compounded amount of ethylene carbonate or propylene carbonate in the mixed solvent is preferably 1.0% or more and 30% or less in percentage by volume. The compounded amount of ethylene carbonate or propylene carbonate is more preferably 20% or more and 75% or less in percentage by volume.

Examples of the electrolyte contained in the nonaqueous electrolytic solution include lithium salts (electrolytes) such as lithium perchlorate (LiClO₄), lithium hexafluorophosphate (LiPF₆), lithium fluoroborate (LiBF₄), lithium hexafluoroarsenate (LiAsF₆), lithium trifluoromethanesulfonate (LiCF₃SO₃), and lithium bis(trifluoromethylsulfonyl)imide [LiN(CF₃SO₂)₂]. Above all, it is preferable to use LiPF₆ or LiBF₄.

The amount of the electrolyte dissolved in the nonaqueous solvent is desirably adjusted to 0.5 mol/L or more and 2.0 mol/L or less.

The nonaqueous electrolytic solution contains an additive, in addition to the nonaqueous solvent, the second solvent, and the electrolyte. The additive includes two or more types of compounds of: at least one compound containing fluorine; and at least one compound containing no fluorine. Examples of the compound containing fluorine include fluoroethylene carbonate (FEC). In addition, vinylene carbonate (VC), ethylene sulfite (ES), propane sultone (PS), etc. can be used as the compound containing no fluorine. The amount of the additive mixed in the mixed solvent (nonaqueous electrolytic solution) is preferably 0.1% or more and 20% or less in percentage by mass. The amount is more preferably 0.5% or more and 10% or less in percentage by mass. This additive is reductively decomposed during charge/discharge, and deposited as an SEI film on the negative electrode. The reductively decomposed compound containing fluorine is selectively deposited on the Si phase or SiOₓ phase. The reductively decomposed compound containing no fluorine is selectively deposited on the carbonaceous matter. The excessive decomposition of the solvent or lithium salt in the electrolytic solution can be inhibited. It is to be noted that the additive is partially decomposed reductively to turn into a film for the negative active material after the first charge, whereas the rest remains in the electrolyte. In addition, the additive is reductively decomposed during the initial charge of 20 cycles or less of charge and discharge from the first charge, or until the additive is all reductively reduced and run out of.

5) Separator 104

In the case of using a nonaqueous electrolytic solution, and in the case of using a polymer electrolyte impregnated with an electrolyte, the separator 104 can be used. For the separator 104, a porous separator is used. For example, porous films, synthetic resin nonwoven fabrics, etc. containing polyethylene, polypropylene or polyvinylidene fluoride (PVdF) can be used as the material for the separator 104. Above all, a porous film made from polyethylene or polypropylene, or from both polyethylene and polypropylene is preferred because the film can improve the safety of the secondary battery.

The thickness of the separator 104 is preferably adjusted to 30 μm or less. There is a possibility that the thickness in excess of 30 μm may increase the distance between the positive and negative electrodes to increase the internal resistance. Furthermore, the lower limit of the thickness is preferably adjusted to 5 μm. There is a possibility that the thickness less than 5 μm may significantly decrease the strength of the separator 104 to make internal short-circuit likely to be caused. The upper limit of the thickness is more preferably adjusted to 25 μm, and the lower limit is more preferably adjusted to 1.0 μm.

The thermal shrinkage of the separator 104 is preferably 20% or less when the separator is allowed to stand under the condition of 120° C. for 1 hour. The thermal shrinkage in excess of 20% makes short circuit more likely to be caused by heating. The thermal shrinkage is more preferably adjusted to 15% or less.

The porosity of the separator 104 preferably falls within the range of 30% or more and 70% or less. This is for the following reason. There is a possibility that the porosity less than 30% may make it difficult for the separator 104 to achieve high electrolyte retention performance. On the other hand, there is a possibility that the porosity in excess of 60% may make it impossible for the separator 104 to achieve sufficient strength. A more preferred range of the porosity is 35% or more and 70% or less.

The air permeability of the separator 104 is preferably 500 seconds/100 cm³ or less. There is a possibility that the air permeability in excess of 500 seconds/100 cm³ may make it difficult for the separator 104 to achieve a high lithium ion mobility. Furthermore, the lower limit of the air permeability is 30 seconds/100 cm³. This is because there is a possibility that the air permeability less than 30 seconds/100 cm³ may make it impossible to achieve sufficient separator strength.

The upper limit of the air permeability is more preferably adjusted to 300 seconds/100 cm³, and the lower limit is more preferably adjusted to 50 seconds/100 cm³.

Next, a battery pack with the nonaqueous electrolyte secondary battery described above will be described.

The battery pack according to an embodiment includes one or more nonaqueous electrolyte secondary batteries (i.e., single batteries) according to the foregoing embodiment. The single batteries are used as cells of the battery pack. When the battery pack includes a plurality of single batteries, the single batteries are electrically connected and disposed in series with each other, in parallel with each other, or in series and parallel with each other.

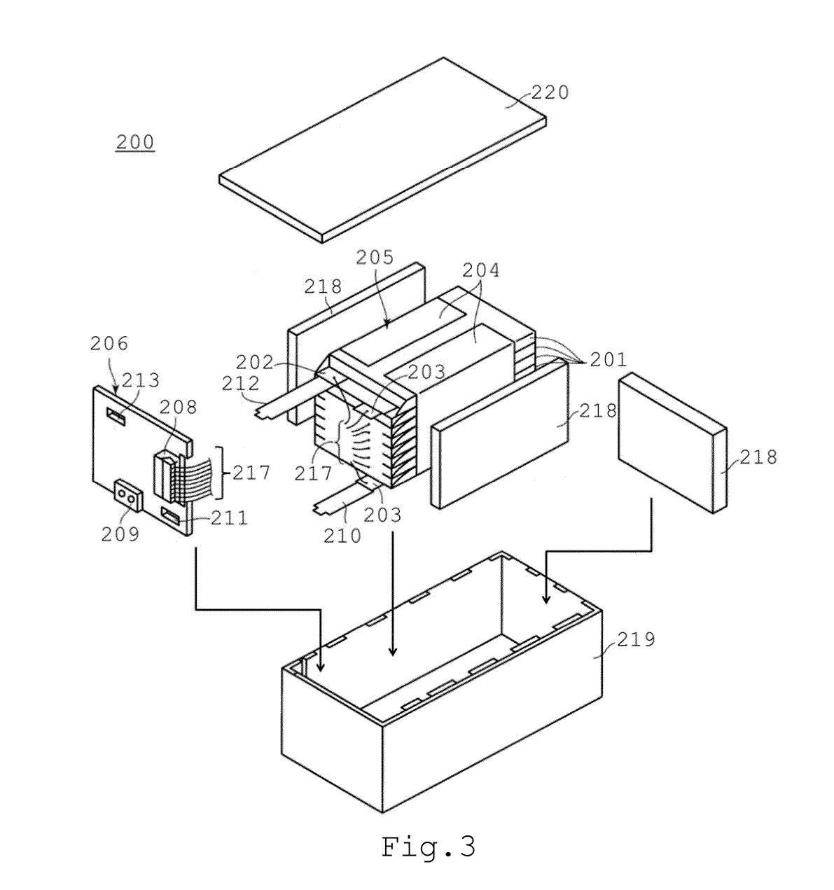

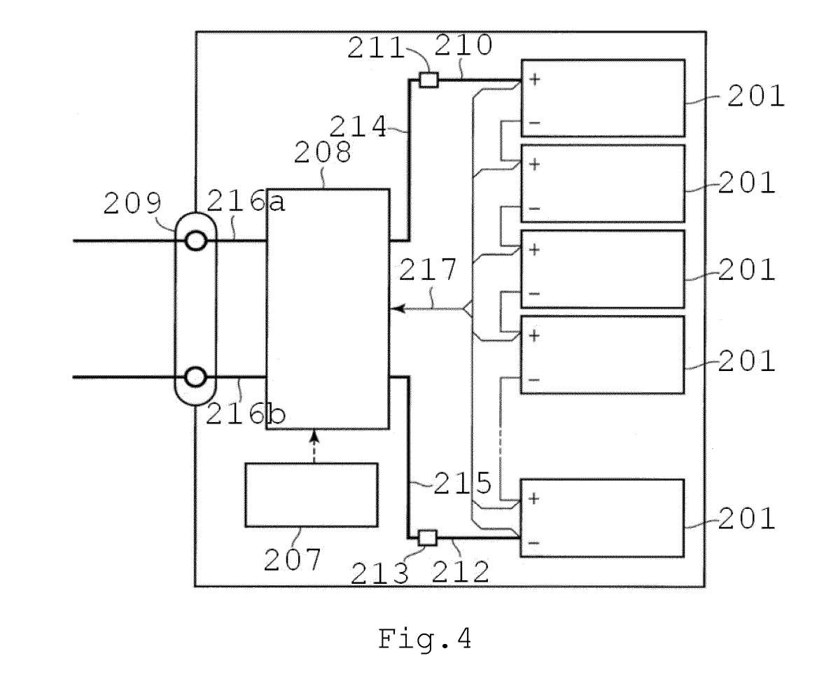

The battery pack will be specifically described with reference to a schematic diagram in FIG. 3 and a block diagram in FIG. 4. The battery pack shown in FIG. 3 includes, as single batteries 201, flat nonaqueous electrolyte batteries 100 each shown in FIG. 1.

The plurality of single batteries 201 are stacked so that a negative terminal 202 and a positive terminal 203 extend out externally in the same orientation, and bundled with an adhesive tape 204, thereby constituting an assembled battery 205. These single batteries 201 are, as shown in FIG. 4, electrically connected in series with each other.

A printed circuit board 206 is placed so as to face the side surfaces of the single batteries 201 from which the negative terminal 202 and the positive terminal 203 extend out. The printed circuit board 206 is, as shown in FIG. 4, mounted with a thermistor 207, a protection circuit 208, and a conduction terminal 209 for external devices. It is to be noted that the surface of the protection circuit board 206, which faces the assembled battery 205, has an insulation plate (not illustrated) attached thereto in order to avoid unwanted connections to wires of the assembled battery 205.

A positive electrode-side lead 210 is connected to the positive terminal 203 located at the lowermost layer of the assembled battery 205, and the other end of the lead is inserted in and electrically connected to a positive electrode-side connector 211 of the printed circuit board 206. A negative electrode-side lead 212 is connected to the negative terminal 202 located at the uppermost layer of the assembled battery 205, and the other end of the lead is inserted in and electrically connected to a negative electrode-side connector 213 of the printed circuit board 206. These connectors 211 and 213 are connected to the protection circuit 208 via traces 214 and 215 formed on the printed circuit board 206.

The thermistor 207 is used to detect the temperature of the assembled battery 205, and the detection signal therefrom is transmitted to the protection circuit 208. The protection circuit 208 is capable of, under a predetermined condition, disconnecting a positive-side trace 216a and a negative-side trace 216b between the protection circuit 208 and the conduction terminal 209 for external devices. The predetermined condition refers to, for example, when the temperature detected by the thermistor 207 is equal to or higher than a predetermined temperature. Alternatively, the predetermined condition refers to when the single batteries 201 are detected as being overcharged or overdischarged, carrying overcurrent, or the like. The detection of overcharge or the like is performed with respect to each of the individual single batteries 201 or with respect to the single batteries 201 as a whole. When the single batteries 201 are individually subjected to the detection, the battery voltage may be detected, or the positive electrode potential or negative electrode potential may be detected. In the latter case, a lithium electrode, which is used as a reference electrode, is inserted into each of the individual single batteries 201. In the case of FIGS. 3 and 4, wires 217 are connected to the respective single batteries 201 for voltage detection, and the detection signals are transmitted via the wires 217 to the protection circuit 208.

The three side surfaces of the assembled battery 205, except for the surface from which the positive terminal 203 and the negative terminal 202 project, are provided with respective protection sheets 218 made from rubber or resin.

The assembled battery 205 is, together with the protection sheets 218 and the printed circuit board 206, housed in a case 219. More specifically, the protection sheets 218 are placed respectively on both inner surfaces along long sides of the case 219 and on an inner surface along a short side of the case, and the printed circuit board 206 is placed on the opposite inner surface along the other short side of the case. The assembled battery 205 is positioned in the space surrounded by the protection sheets 218 and the printed circuit board 206. A lid 220 is attached to the upper surface of the case 219.

It is to be noted that the assembled battery 205 may be fixed with a heat-shrinkable tape instead of the adhesive tape 204. In this case, a protection sheet is placed on both side surfaces of the assembled battery, a heat-shrinkable tape is wound around the battery with the protection sheets, and the heat-shrinkable tape is then shrunk by heat to bundle the assembled battery.

Although FIGS. 3 and 4 show the arrangement of the single batteries 201 connected in series, the single batteries may be connected in parallel for increasing the battery capacity, or a series connection may be combined with a parallel connection. The assembled battery packs may further be connected in series or in parallel.

According to the present embodiment as described above, with the nonaqueous electrolyte secondary batteries according to the foregoing embodiment, which have excellent charge-discharge cycle performance, a battery pack can be provided which has excellent charge-discharge cycle characteristics.

It is to be noted that the form of the battery pack is changed appropriately depending on the intended use. The battery pack is also preferably used in applications that require a small size and a high capacity. Specific examples of the applications include: power sources for smartphones and digital cameras; and automotive batteries for two- to four-wheeled hybrid electric vehicles, two- to four-wheeled electric vehicles, and electrically assisted bicycles.

With reference to specific examples of embodiments, advantageous effects thereof will be mentioned below. However, the embodiments are not to be limited to the examples.

### Example 1

### Preparation of Negative Electrode Active Material

As for raw materials, used were amorphous SiO of 300 nm in average particle size as the SiO_{y}, graphite of 6 μm in average particle size as the carbonaceous matter, and furfuryl alcohol. The mixture proportions were adjusted to SiO:graphite:furfuryl alcohol=3:0.5:5 in mass ratio. To the furfuryl alcohol, water corresponding to 1/10 of the alcohol in mass was added, and graphite, and then SiO were added, and each agitated. Thereafter, dilute hydrochloric acid corresponding to 1/10 of the furfuryl alcohol in mass was added, agitated, and then allowed to stand for solidification by polymerization. The obtained solid matter was subjected to firing in Ar at 1100° C. for 3 hours, cooled to room temperature, and then subjected to grinding with a grinding mill until the average particle size reached 30 μm, thereby providing a negative electrode active material.

### <Preparation of Negative Electrode Active Material Layer>

To the obtained negative electrode active material (72 mass %), graphite: 12 mass %, an imide binder: 16 mass % or less were added, and 55 mass % of NMP was mixed with the mixed sample to provide slurry for negative electrode active material layer. This slurry was formed into the shape of a sheet on Cu foil of 20 μm in thickness, and dried at 120° C. in air. The dried negative electrode active material layer was pressed at a pressure of 3.5 t/cm², and subjected to heat treatment in Ar at 400° C. for 1 hour.

### <Preparation of Positive Electrode Active Material Layer>

Added were a mixture of lithium-containing nickel-cobalt-manganese oxide (LiNi_{0.8}CO_{0.1}Mn_{0.1}O₂) and LiCoO2 as positive electrode active material: 70 mass %, an efficiency adjusting material: 22.8 mass %, conducting aid carbon: 4.5 mass %, a PVdF binder: 2.7 mass % or less, and 46 mass % of NMP was mixed with the mixed material to provide slurry for positive electrode active material layer. This slurry was formed into the shape of a sheet on Al foil of 12 μm in thickness, and dried at 120° C. in air, and the dried positive electrode active material layer was pressed at a pressure of 3.5 t/cm².

<Preparation of Test Cell>

The obtained negative electrode active material layer was cut into any size as a test electrode. For the counter electrode, the positive electrode prepared in <Preparation of Positive Electrode Active Material Layer> or a metal Li was made into any size, and for a reference electrode, a metal Li was used. EC and DEC mixed at a volume ratio of 1:2 were used as a nonaqueous electrolytic solution, and LiN(CF₃O₂)₂ adjusted to 1 mol/L was used for the electrolyte. As an additive put in the nonaqueous electrolytic solution, FEC and VC mixed at a mass ratio of 1:1 were used and added by 1 mass, to the nonaqueous electrolytic solution. These cell constituent materials were prepared in an argon atmosphere, and put in a glass container, the container was hermetically sealed as a test cell, and two test cells were prepared in the same way.

<Charge-Discharge Test>

One of the two test cells prepared in the same way was charged and discharged once at a 0.1 C rate in the range of 0.01 V to 1.5 V with respect to the Li potential to confirm the capacity. Thereafter, the cell was charged at the 0.1 C rate up to 0.01 V. In addition, the other cell was charged and discharged once at a 0.1 C rate in the range of 0.01 V to 1.5 V to confirm the capacity, and then subjected to a charge-discharge test of 500 cycles at a 1 C rate. For the test cells subjected to the cycle test, the ratio between charging capacity and discharging capacity (discharging capacity/charging capacity) was calculated for each cycle from 100 cycles to 300 cycles, and this value was regarded as a charge/discharge efficiency.

Table 1 shows both the maximum value and minimum value of the charge/discharge efficiency.

<Electron Microscope Observation>

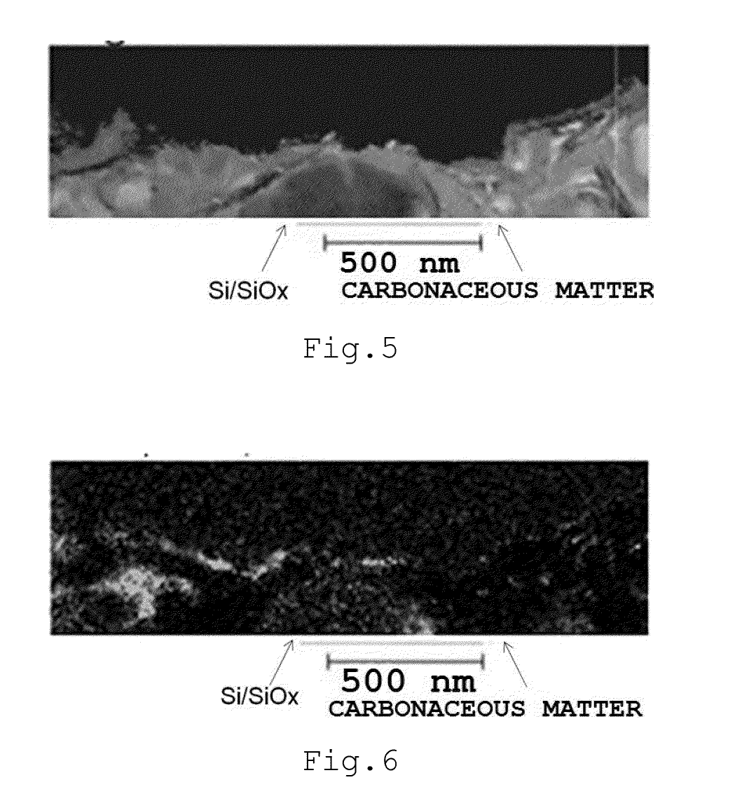

The test electrode was taken out from the test cell for the charge-discharge test, and a cut surface of the test electrode was prepared with the use of a focused ion beam processing and observation system (FIB: Focused Ion Beam System). The cut surface processing may be achieved in any way as long as a precise cut surface of the electrode is obtained, and an ion milling system may be used besides FIB. The obtained cut surface of the test electrode was observed at the depth from the electrode surface down to 2 μm with the use of a scanning transmission electron microscope (STEM: Scanning Transmission Electron Microscope) or a transmission electron microscope (TEM: Transmission Electron Microscope), and the Si and C concentrations in the active material layer were measured by energy dispersive X-ray analysis (EDX: Energy Dispersive X-ray spectrometry) to identify Si particles and carbon particles in the active material. The TEM cross-sectional image is shown in FIG. 5. Thereafter, when the distribution of F was measured at the depth of 300 nm from the test electrode surface, F was prominently detected at the surface section of the test electrode on the Si particles, whereas almost no F was detected at the surface section of the test electrode on the carbon particles (FIG. 6). In the detection of F, the image to be analyzed is preferably subjected to noise reduction in advance.

Thus, the average fluorine ion concentration (F_Si) over 100 nm was measured mainly from a point with the highest Si concentration in the Si particle to the closest surface section of the test electrode. The F_Si represents the concentration of fluorine covering the Si phase and SiOₓ phase. In addition, likewise, the average fluorine ion concentration (F_C) over 100 nm was measured mainly from a point with the highest C concentration in the carbon particle to the closest surface section of the test electrode, and the ratio between F_Si and F_C (F_Si/F_C) was calculated. The F_C represents the concentration of fluorine covering the carbonaceous matter. In this case, when the F_C is equal to or less than the lower detection limit, (F_Si/F_C)=will be figured out. When the F_C is detected, the F_Si/F_C of 3.5 or more is determined as a negative electrode active material according to an embodiment. It is to be noted that the F_Si/F_C is 3 or less clearly fail to show the advantageous effect of the cycle characteristics and charge/discharge efficiency, and the negative electrode active material is thus treated as having no film deposition selectivity (corresponding to the prior art) in an embodiment. Furthermore, the ratio between the fluorine ion concentrations shown here may be a counting ratio as obtained by EDX.

### Examples 2 to 9, Comparative Examples 1 to 2

The negative electrode active material layer and the positive electrode active material layer were prepared as in the case of Example 1, while the types of the lithium salt and additive for use in the nonaqueous electrolyte were changed, and test cells were prepared in accordance with the same procedure. Thereafter, the <Charge-Discharge Test> and <Electron Microscope Observation> were carried out as in the case of Example 1. Table 1 lists the F concentration ratios all together obtained from the compositions of the nonaqueous electrolytes according to Examples 1 to 9 and Comparative Examples 1 to 2 and the electron microscope observations.

TABLE 1

| | | | | Charge/ |
|---|---|---|---|---|
| | | | | Discharge |
| | | | | Efficiency |
| | Lithium | | | during |
| | Salt | Additive | F_Si/F_C | Cycle |
| Example 1 | LiN(CF₃SO₂)₂ | FEC + VC | infinite | 99.7-99.8% |
| Example 2 | LiN(CF₃SO₂)₂ | FEC + ES | infinite | 99.5-99.7% |
| Example 3 | LiN(CF₃SO₂)₂ | FEC + PS | infinite | 99.5-99.7% |
| Example 4 | LiPF₆ | FEC + VC | 10.9 | 99.4-99.6% |
| Example 5 | LiPF₆ | FEC + ES | 15.7 | 99.4-99.6% |
| Example 6 | LiPF₆ | FEC + PS | 3.8 | 99.4-99.6% |
| Example 7 | LiBF₄ | FEC + VC | 20.9 | 99.4-99.6% |
| Example 8 | LiBF₄ | FEC + ES | 19.3 | 99.4-99.6% |
| Example 9 | LiBF₄ | FEC + PS | 10.6 | 99.4-99.6% |
| Comparative | LiN(CF₃SO₂)₂ | VC | 1.5 | 91.1-99.2% |
| Example 1 | | | | |
| Comparative | LiN(CF₃SO₂)₂ | No | 1.1 | 89.2-97.1% |
| Example 2 | | Additive | | |

As a result, in Examples 1 to 9, the F_Si/F_C is 3.8 or more, the F concentration in the SEI film formed on the Si particle in the negative electrode active material layer is higher as compared with the F concentration of the SEI film formed on the carbon particle in the negative electrode active material layer. Accordingly, it has been confirmed the SEI film formed on the Si particle differs in composition from the SEI film formed on the carbon particle. On the other hand, the equivalent ratio confirmed in Comparative Examples 1 to 2 is 2 or less, there is no substantial difference in the F concentration, and it has been thus confirmed that the same SEI films are formed on the Si particle and the carbon particle in the comparative examples.

In addition, when these examples are compared in terms of charge/discharge efficiency during the cycle, Examples 1 to 9 with FEC, VC, and ES and PS mixed maintain high values of 99.4% or more, and show stable values. However, Comparative Examples 1 to 2 vary in charge/discharge efficiency, show a tendency to lower the efficiency as compared with the examples.

Accordingly, the formation of films which differ in composition on the Si particle and on the carbon particle can achieve a stable charge/discharge efficiency for the cell, thereby improving the cycle characteristics.

In this specification, some of the elements are denoted by chemical symbols.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A nonaqueous electrolyte secondary battery comprising:
a positive electrode containing at least a positive electrode active material;
a negative electrode containing at least a negative electrode active material; and
a nonaqueous electrolyte,
wherein the nonaqueous electrolyte contains an organic solvent with a lithium salt dissolved therein and an additive, and
the negative electrode active material contains at least one metal selected from Si and Sn, at least one or more selected from an oxide of the metal and an alloy containing the metal, and a carbonaceous matter, and wherein
a fluorine concentration of a film A formed on the metal, the oxide of the metal, or the alloy containing the metal in the negative electrode active material is higher than a fluorine concentration of a film B formed on the carbonaceous matter,
the additive includes at least one compound containing fluorine and at least one compound containing no fluorine, or
an electrolyte after initial charge contains at least one fluorine-containing additive.

2. The battery according to claim 1, wherein the fluorine concentration of the film formed on the metal, the oxide of the metal, or the alloy containing the metal in the negative electrode active material is 3.5 times or more as high as the fluorine concentration of the film formed on the carbonaceous matter.

3. The battery according to claim 1, wherein the additive includes at least one compound containing fluorine, and at least one compound containing no fluorine.

4. The battery according to claim 1, wherein the additive includes at least one compound containing fluorine, and at least one compound containing no fluorine.

5. The battery according to claim 3, wherein the compound containing fluorine is fluoroethylene carbonate, and
the compound containing no fluorine is at least one or more selected from vinylene carbonate, ethylene sulfite, and propane sultone.

6. The battery according to claim 1, wherein the compound containing fluorine is fluoroethylene carbonate, and
the compound containing no fluorine is at least one or more selected from vinylene carbonate, ethylene sulfite, and propane sultone.

7. The battery according to claim 4, wherein the compound containing fluorine is fluoroethylene carbonate, and
the compound containing no fluorine is at least one or more selected from vinylene carbonate, ethylene sulfite, and propane sultone.

8. A battery pack comprising:
a nonaqueous electrolyte secondary battery as a cell,
wherein the nonaqueous electrolyte secondary battery comprises,
a positive electrode containing at least a positive electrode active material,
a negative electrode containing at least a negative electrode active material, and
a nonaqueous electrolyte,
wherein the nonaqueous electrolyte contains an organic solvent with a lithium salt dissolved therein and an additive, and
the negative electrode active material contains at least one metal selected from Si and Sn, at least one or more selected from an oxide of the metal and an alloy containing the metal, and a carbonaceous matter, and wherein
a fluorine concentration of a film A formed on the metal, the oxide of the metal, or the alloy containing the metal in the negative electrode active material is higher than a fluorine concentration of a film B formed on the carbonaceous matter,
the additive includes at least one compound containing fluorine and at least one compound containing no fluorine, or
an electrolyte after initial charge contains at least one fluorine-containing additive.

9. The battery pack according to claim 8, wherein the fluorine concentration of the film formed on the metal, the oxide of the metal, or the alloy containing the metal in the negative electrode active material is 3.5 times or more as high as the fluorine concentration of the film formed on the carbonaceous matter.

10. The battery pack according to claim 8, wherein the additive includes at least one compound containing fluorine, and at least one compound containing no fluorine.

11. The battery pack according to claim 8, wherein the additive includes at least one compound containing fluorine, and at least one compound containing no fluorine.

12. The battery pack according to claim 10, wherein the compound containing fluorine is fluoroethylene carbonate, and
the compound containing no fluorine is at least one or more selected from vinylene carbonate, ethylene sulfite, and propane sultone.

13. The battery pack according to claim 8, wherein the compound containing fluorine is fluoroethylene carbonate, and
the compound containing no fluorine is at least one or more selected from vinylene carbonate, ethylene sulfite, and propane sultone.

14. The battery pack according to claim 11, wherein the compound containing fluorine is fluoroethylene carbonate, and
the compound containing no fluorine is at least one or more selected from vinylene carbonate, ethylene sulfite, and propane sultone.
